(19) United States
(12) Patent Application Publication
(10) Pub. No.: US 2011/0040980 A1
(43) Pub. Date: Feb. 17, 2011

(54) File Management Safe Deposit Box

(75) Inventors: Duncan Robert Kerr, San Francisco, CA (US); David R. Falkenburg, San Jose, CA (US)

Correspondence Address: FISH & RICHARDSON P.C., PO BOX 1022, MINNEAPOLIS, MN, 55440-1022, US

(73) Assignee: Apple Inc.

(21) Appl. No.: 12/540,053

(22) Filed: Aug. 12, 2009

(51) Int. Cl. G06F 12/14; G06F 17/30; G06F 7/04; G06F 11/30; G06F 11/00; G06F 3/048

(52) U.S. Cl. 713/189; 726/28; 715/839; 707/E17.007; 715/769

(57) ABSTRACT

Safe deposit box functionality is disclosed. In one aspect, first input dragging-and-dropping a first file representation onto a safe deposit box icon is received, and a file corresponding to the first file representation is encrypted. Second input selecting the safe deposit box icon is received from a user. The user's identity is verified in response to the second input. A safe deposit box window, including a second file representation of the file, is displayed. A user is allowed access to the file in response to third input selecting the second file representation.

### TECHNICAL FIELD

This subject matter is generally related to providing user interface elements for file management.

### BACKGROUND

Computer users typically store files of varying importance, and varying secrecy, on their computers. Users may wish to have additional copies of important files to minimize the risk of loss. Users, especially those who share a computer with others or fear their computer being stolen, may wish to secure secret files to minimize the risk of someone viewing the files that should not view them. While various backup programs and encryption software suites are available to users, these are often cumbersome and time consuming for a user to set up.

### SUMMARY

A safe deposit box for securing important user files is disclosed. In one aspect, when a user drags-and-drops a file representation onto a safe deposit box icon, the file is secured. In another aspect, when a user selects the safe deposit box icon and verifies his or her identity, the user can access secured files through a safe deposit box window. Other implementations are disclosed which are directed to systems, methods, and apparatus including computer-readable mediums.

Particular embodiments of the subject matter described in this specification can be implemented to realize one or more of the following advantages. Files can be securely stored. Copies of important files can be automatically generated and protected. File loss can be minimized. Confidential information within a file can be protected. Users can more easily secure the files that matter the most to them. Users can be provided with an interface for protecting valuables that mimics a physical safe deposit box at a bank, a personal safe, or another way of safekeeping valuables. This interface can allow access to files for only short periods of time to minimize the risk of an unauthorized user viewing the files.

### DESCRIPTION OF DRAWINGS

FIG. 1A illustrates an example desktop user interface on a user's computer.

FIG. 1B illustrates example user actions dragging-and-dropping a file representation onto a safe deposit box icon.

FIG. 1C illustrates the user interface after File A has been added to the safe deposit box.

FIG. 2 illustrates an alternative user interface that presents the safe deposit box icon in a dock instead of on the desktop.

FIGS. 3A and 3B illustrate an example of accessing files or folders in the safe deposit box.

FIG. 4 illustrates an example system showing a user computer coupled to various storage devices.

FIG. 5 illustrates an example architecture for a safe deposit box manager.

FIG. 6 is a flow diagram of an example process for receiving input adding a file to a safe deposit box.

FIG. 7 is a flow diagram of an example process for adding a file to a safe deposit box and allowing a user access to the file through the safe deposit box.

Like reference numbers and designations in the various drawings indicate like elements.

### DETAILED DESCRIPTION

### Example User Interfaces

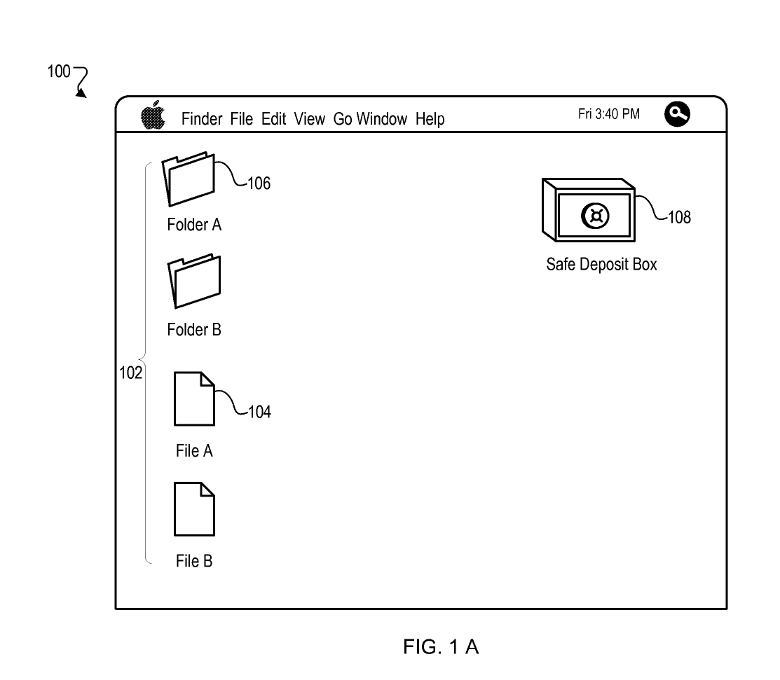

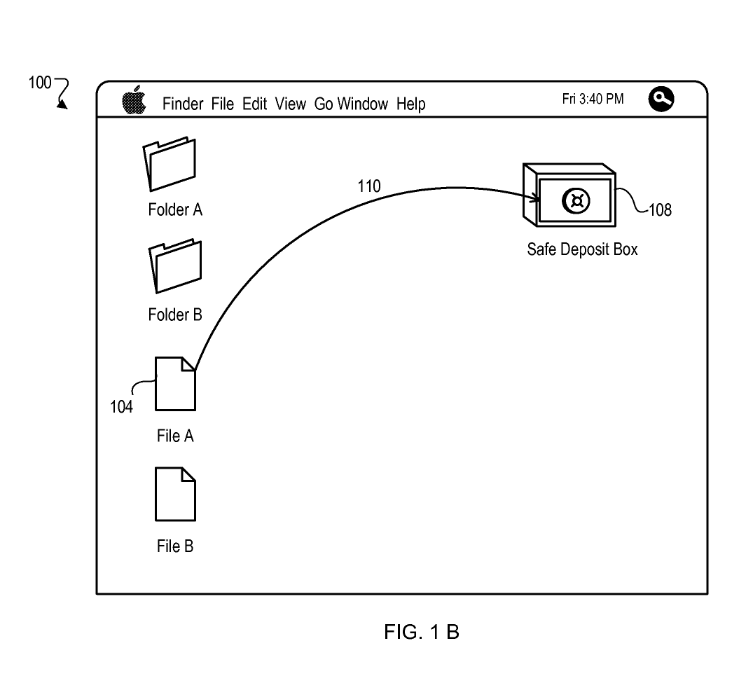

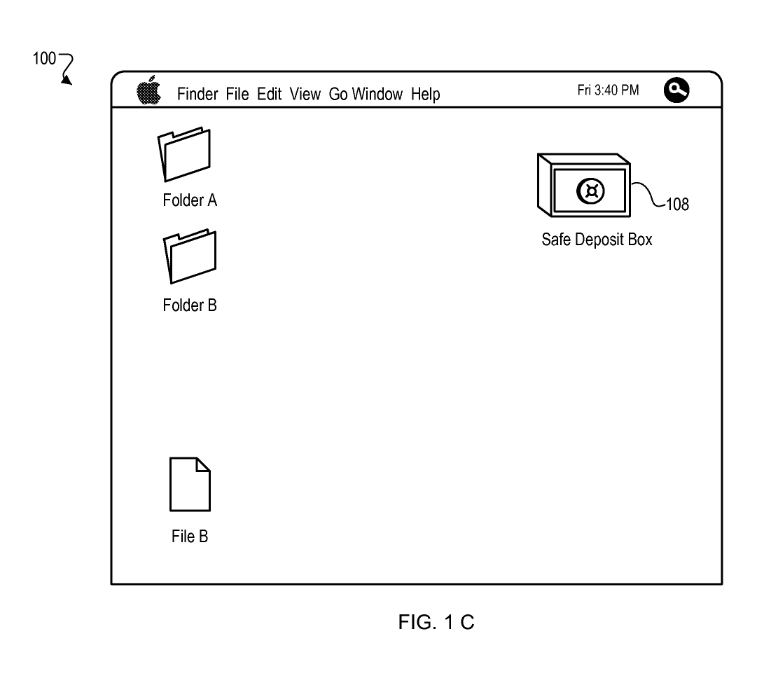

FIG. 1A illustrates an example desktop user interface 100 on a user's computer. The user interface presents file representations 102 corresponding to files (e.g., file representation 104 for File A) and folders (e.g., file representation 106 for Folder A) stored on the computer or on storage devices accessible by the computer. Each folder can include multiple files or a nested hierarchy of folders and files. Each file representation can be an icon, an alphanumeric file identifier such as the file name, or any other visual representation of a file or folder.

The user interface also presents safe deposit box icon 108. The safe deposit box icon 108 represents a safe deposit box program that protects files that are important to a user, much as a physical safe deposit box at a bank, or a safe in a user's home, protects the user's valuables. In some implementations, when a user hovers a cursor over the safe deposit box icon, a window hovers over or near the safe deposit box icon that displays information about the safe deposit box (e.g., last time opened, number of files, current settings, etc.)

### Adding Files and Folders to the Safe Deposit Box

A user indicates that files or folders should be added to the safe deposit box by dragging and dropping file representations of the files or folders onto the safe deposit box icon 108. Dragging a file representation of a folder indicates that the folder, and all of its contents, should be added to the safe deposit box.

FIG. 1B illustrates example user actions dragging-and-dropping the file representation 104 for File A onto the safe deposit box icon 108. As shown in FIG. 1B, a user selects (e.g., with a mouse or other input device, such as a finger on a multi-touch screen, or stylus on a touch screen) the file representation 106 of File A and drags the representation to the icon of the safe deposit box 108, as illustrated by arrow 110. When the user drops the file representation 104 onto the safe deposit box icon 108 (e.g., by releasing the mouse), the computer provides File A to an underlying safe deposit box program that secures the file. The safe deposit box program removes the file representation 104 shown on the user interface so that the user must open the safe deposit box to view the file representation 104.

FIG. 1C illustrates the user interface 100 after File A has been added to the safe deposit box. The representation for File A is no longer shown in the user interface.

In some implementations, the safe deposit box program takes various actions to further secure the file from one, or both, of two main dangers: someone without authorization accessing the file, and a physical loss of the file due to failure of a storage device storing the file. To protect against someone without authorization accessing the file, the safe deposit box program can encrypt the file (e.g., using standard encryption techniques), obfuscate the file name (e.g., by renaming the file with an alphanumeric phrase that the safe deposit box associates with the old file name), or take other actions. In some implementations, the safe deposit box program copies the file to a secure location and deletes or securely deletes the original version of the file. Secure deletion is performed, for example, by overwriting the file with alternating patterns of data that make it difficult to recover the file. An example standard for secure deletion is the U.S. Department of Defense standard 5220.22-M.

To protect against physical loss of the file, the safe deposit box program can make one or more copies of the file and store them in different places in local storage on the user computer or in external or remote storage accessible to the user computer.

In some implementations, when the user drags the file representation 102 over the safe deposit box icon 108, the safe deposit box icon 108 is modified (e.g., visually changes). For example, the door on the safe deposit box icon 108 could swing open, the safe deposit box could change colors, or a window displaying information about the file (date last modified, who had accessed the file, etc.) could be displayed beside the safe deposit box icon 108. Other feedback, including aural and tactile feedback, is also possible. For example, the user computer could make a noise mimicking a creaky door swinging open. In some implementations, the feedback continues throughout the time the file representation 102 is over the safe deposit box icon 108.

In some implementations, when the user drops the file representation 102 onto the safe deposit box icon 108, the safe deposit box icon is modified. For example, the door on the safe deposit box icon 108 could swing closed. As another example, when the safe deposit box icon 108 is modified when a user drags the file representation over the icon, the safe deposit box icon 108 can return to its original state when the user drops the file onto the icon. Other feedback is also possible, for example, the user computer could make a noise mimicking a door slamming closed.

In some implementations, when a user drops the file representation onto the safe deposit box icon 108, the user is presented with a preferences screen that allows the user to specify various preferences for the file. For example, the preferences screen can allow a user to specify one or more of permissions for the file (e.g., can the file be modified or just viewed, and can the file be transferred or copied from the computer), how many copies of the file should be made, a storage preference policy indicating where copies should be stored, and whether the file should be encrypted. The preference screen can also allow a user to specify an importance level of the file (e.g., according to a rating scale). This importance level can be mapped to other preference values, such as how many copies of the file should be made and whether the file should be encrypted (e.g., important files should encrypted, and the more important the file is, the more copies should be made).

While FIGS. 1B-C illustrate dragging and dropping a file from a desktop user interface to the safe deposit box, the file representation can be dragged from other interfaces, for example, in a folder open in the interface 100, or in an application (e.g., a backup application) open in the interface 100. Also, while FIGS. 1A-C illustrate dragging and dropping a file representation for a file, the same technique can be used to add a folder (and each file in the folder) to the safe deposit box.

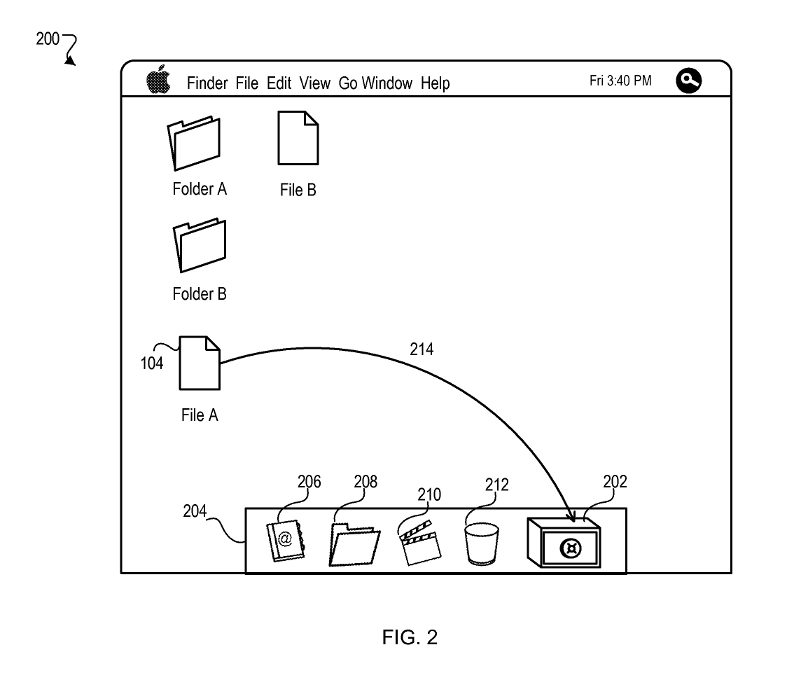

FIG. 2 illustrates an alternative user interface 200 that presents the safe deposit box icon 202 in dock 204 instead of on the desktop. The dock includes icons for various applications (e.g., icons 202, 206, 210, 212). The user launches one of the applications by clicking on the corresponding icon in the dock. The dock can also include icons for files and folders (e.g., icon 208). A user loads a file or opens a folder by clicking on the appropriate icon in the dock.

The dock 204 includes safe deposit box icon 202 similar to the safe deposit box icon 108 shown in FIGS. 1A-C. To add File A to the safe deposit box, the user drags and drops the file representation 104 of File A onto the safe deposit box icon 202 (as illustrated by arrow 214), much as the user does when the safe deposit box is presented on the desktop.

### Accessing Files or Folders in the Safe Deposit Box

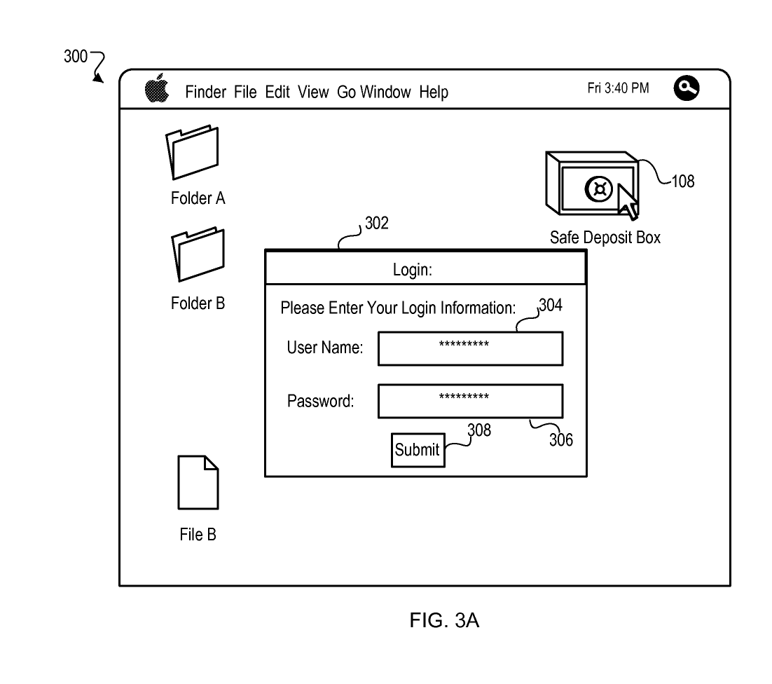

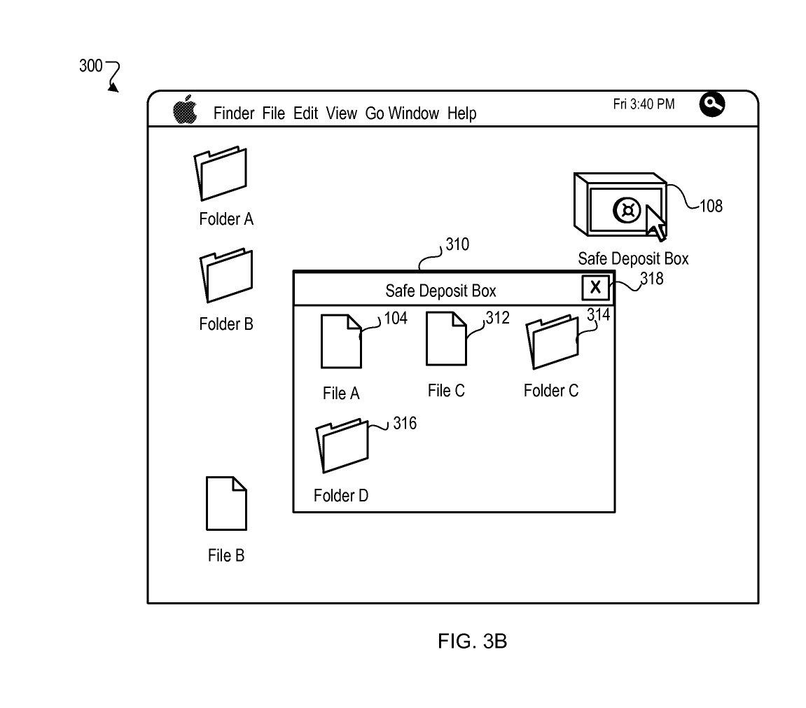

FIGS. 3A and 3B illustrate an example of accessing files or folders in the safe deposit box. As shown in FIG. 3A, the user requests access to the safe deposit box by double-clicking on the safe deposit box icon 108. In response to the selection, the computer presents login window 302 in the user interface through which the user can verify his or her identity. The login window 302 prompts the user for a user name and password. The user enters his user name and password into the boxes 304 and 306, and clicks the submit button to indicate that his entry is complete. The system then verifies the user's identity using the user name and password (e.g., by matching the user name and password against a stored group of valid user names and passwords).

If the user's identity is verified, the system displays safe deposit box window 310, as illustrated in FIG. 3B. The safe deposit box window 310 presents representations of any files or folders the user has added to his or her safe deposit box. The file representation 104 of File A is included, as are file representations of File C 312, Folder C 314, and Folder D 316. The user can navigate through the folders presented in the safe deposit box window 310 much as the user would navigate through folders presented in a navigational window (e.g., by clicking on a folder representation to view its contents). In some implementations, the safe deposit box window 310 is graphically connected to the safe deposit box icon.

A user opens a file represented in the safe deposit box window 310 by clicking on the corresponding file representation. For example, a user can open File A by clicking on the file representation 104 for file A. The computer will then decrypt the file, if necessary, and present the file to the user. In some implementations, a user can also hover a cursor over a file or folder to be presented with a hover window that displays information about the file or folder (e.g., date last modified, contents of a folder, a thumbnail view of the first page of a file, preference policy settings for the file or folder, etc.)

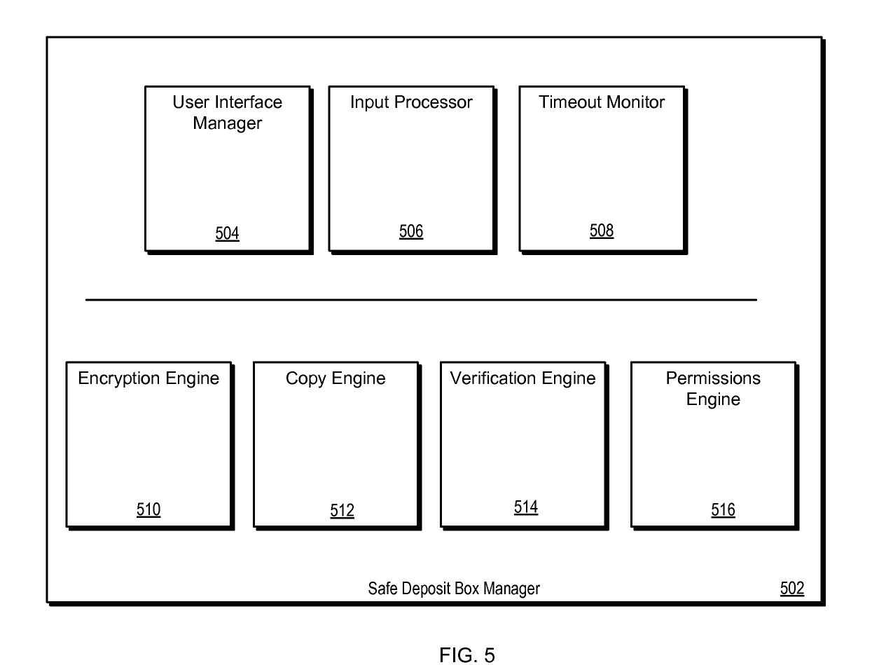

In some implementations, once the user's identity is verified, the computer only displays the safe deposit box window 310 for a given period of time. The period of time can be fixed (e.g., 5 minutes) or can be determined based on an indication of whether the user is still using the window, for example, as described in more detail below with reference to FIG. 5. In other implementations, the computer displays the safe deposit box window until the user indicates that the window should be closed (e.g., by selecting the close button 318). In some implementations, when the safe deposit box window 310 closes, the computer also closes any files that were opened from the safe deposit box window 310. In other implementations, those files remain open.

### Example Computer Architecture

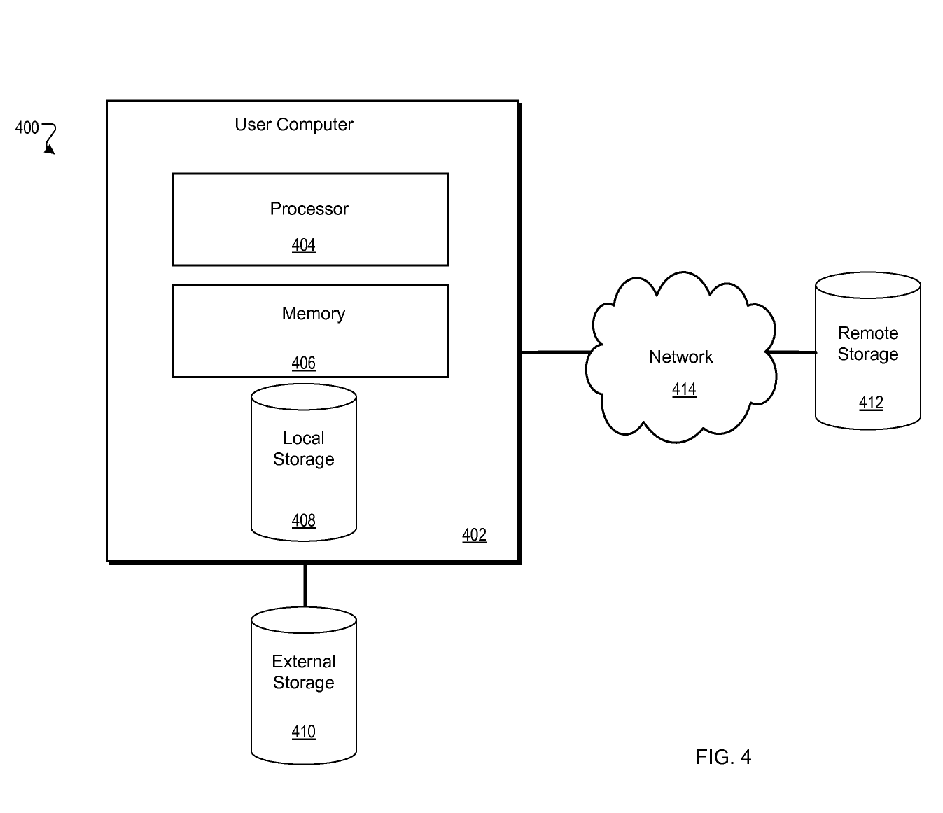

FIG. 4 illustrates an example system 400 showing a user computer 402 coupled to various storage devices. The user computer 402 has a processor 404, memory 406, and local storage 408. The local storage can be a computer readable medium. The computer-readable medium can be a machine-readable storage device, a machine-readable storage substrate, a memory device, or a combination of one or more of them. The user computer 402 is optionally coupled to one or more external storage devices 410 (e.g., computer-readable media external to, but physically coupled, to the user computer 402). The user computer 402 is also optionally coupled to one or more remote storage devices 412 through a network 414 (e.g., the Internet). The remote storage devices can be, for example, other computers such as a server bank or cloud storage.

In some implementations, the user computer 402 further includes a backup component that stores backups of data from the user computer on one or more of the local storage 408, external storage 410, and remote storage 412. In general, the backup component monitors data on the system to detect when files, or other data (e.g., items, information portions, directories, images, system parameters, playlists, address books, e-mails, e-mail folders, application states, preferences, etc.) have been changed. For example, the backup component can run as a background component on the user computer that is constantly monitoring for data changes, or the backup component can be invoked whenever data is modified. In some implementations, the backup component can distinguish between a substantive change (e.g., text within a document being modified) and non-substantive changes (e.g., changes that cancel each other out).

The backup component stores the versions of each file in a backup database that associates each version with previous versions. In some implementations, the backup component stores a complete copy of each file and any subsequent versions of the file. In other implementations, one copy of the original file is stored. When one or more subsequent versions are generated through subsequent backup operations, the backup data contains only the differences between the current version and a past version, thereby saving storage space. The backup data can be compressed and/or encrypted, for example using standard compression techniques (e.g., the ZIP file format) and standard encryption techniques (e.g., the RSA algorithm for public key encryption). Other compression techniques or encryption techniques can also be used.

The backup component also tracks where the backup data for each file is stored, and may optionally handle removing older or otherwise unnecessary backup data at an appropriate time.

### Safe Deposit Box Manager

FIG. 5 illustrates an example architecture for safe deposit box manager 502. The safe deposit box manager provides the functionality described above with reference to FIGS. 1-3.

In general, the safe deposit box manager 502 includes user interface manager 504, input processor 506, timeout monitor 508, encryption engine 510, copy engine 512, verification engine 514, and permissions engine 516. These components can be communicatively coupled to one or more of each other. Though the components identified above are described as being separate or distinct, two or more of the components may be combined in a single process or routine. The functional description provided herein including separation of responsibility for distinct functions is by way of example. Other groupings or other divisions of functional responsibilities can be made as necessary or in accordance with design preferences.

The user interface manager 504 controls what is presented to the user in the user interface (e.g., modifies the safe deposit box icon when appropriate and generates the various windows shown to a user when the user double clicks on the safe deposit box icon). In some implementations, the user interface manager also controls alerts to the user that the safe deposit box window is open. For example, the user interface manager can cause sounds to be produced during the time the safe deposit box is open (e.g., beeping, music, or another indication). In some implementations, the user interface manager presents the open safe deposit box on top of all other open windows on the computer, so that the user is alerted that the safe deposit box is open. In some implementations, the user interface manager presents another visual alert (e.g., across or around the computer display) to alert the user that the safe deposit box is open.

The input processor 506 receives input from a user and processes the input appropriately (e.g., by providing the input to the safe deposit box program or another program responsible for handling the input). In general, the input processor 506 processes input indicating that one or more files or folders are being dragged to the safe deposit box, processes input indicating that the safe deposit box should be opened, processes input that a user's identity should be verified, and processes input that a particular file or folder should be opened.

The timeout monitor 508 determines whether the safe deposit box window should be closed. In some implementations, the timeout monitor monitors for user input indicating that the safe deposit box window should be closed (e.g., a user clicking on a close button on the safe deposit box window or using one or more keyboard inputs to indicate that the window should be closed). In other implementations, the timeout monitor tracks how long the safe deposit box window has been open and closes it after a preset time (e.g., a time period specified by a user in a preference setting, or a hard-coded period of time). The time can be hardcoded into the timeout monitor 508 or can be changed, for example, in response to a user specifying a desired time for the safe deposit box window to stay open (e.g., by setting preferences for the safe deposit box window). In other implementations, the timeout monitor monitors for user presence at or near the computer, and determines that the safe deposit box should be closed when the user is no longer present. For example, the timeout monitor 508 can monitor when the user enters input to the computer (e.g., types characters on a keyboard, clicks with a mouse device, or speaks into a microphone) and if a given period goes by with no input, the timeout monitor can determine that the safe deposit box should be closed. The given time can be hardwired into the timeout monitor or determined, for example, from a user-specified preference. As another example, the timeout monitor 508 can monitor whether the user is physically present at the computer, for example, by monitoring whether signals such as radio frequency (e.g., Bluetooth™) signals received from a device associated with the user (e.g., a badge or cell phone) are being received. As yet another example, the timeout monitor can use an identification of the user present at the computer (e.g., biometric data used to do face identification) to determine whether the user using the computer is still the authorized user. When the timeout monitor 508 detects that the authorized user is no longer physically present, the monitor 508 can immediately close the safe deposit box window, or close it after a predetermined period of time (e.g., a period of time specified by a user in a preference setting, or a hard coded period of time). In other implementations, the timeout monitor 508 closes the safe deposit window then the power state of the computer changes. Examples of changed power states include, but are not limited to a screen saver, display sleep, sleep, shutdown, or hibernate). In still other implementations, the timeout monitor 508 determines that the safe deposit box window should be closed as soon a user indicates that the window should be closed, a sufficient amount of time has passed, the power state of the computer changes, or the authorized user is no longer present.

The encryption engine 510 encrypts files (and optionally copies of files), for example, using standard encryption algorithms. In some implementations, the encryption engine 510 also encrypts backup versions of the files. The encryption engine identifies the backup version of a file, for example, using the backup database described above with reference to FIG. 4.

The copy engine 512 determines how many copies of a file are needed, determines where each copy should be stored, makes the copy and stores the copy in the correct location. In general, the copy engine can store copies on local storage, external storage, or remote storage. The copy engine optionally maintains data indicating where each copy of a given file is stored, e.g., in a database that associates files with links to copies of the file. This data can be used, for example, when the file is securely deleted to ensure that all copies of the file are also removed, or to identify a copy of the file to use as the file when the primary storage for the file fails.

The copy engine 512 can apply various algorithms to determine the number of copies to make. In some implementations, the copy engine 512 always makes a predetermined number of copies of each file. The number can be hardwired into the copy engine or determined from a user preference setting. In other implementations, the copy engine 512 determines the number of copies on a file-by-file basis. In some implementations, the number is determined from user preferences for a particular file (e.g., user preferences specifying the number of copies desired for that file, or an importance level of the file that the copy engine 512 translates into a desired number of copies).

In other implementations, the number is determined based on how much free space is available for storage on the one or more storage devices available to the computer. For example, the copy engine 512 can determine a maximum amount of space available on each accessible storage device, determine how many copies can be stored on each storage device according to the available space, and calculate a maximum number of copies that can be stored. The system can then select the maximum number of copies, or a scaled version of the maximum number (e.g., one-fourth of the maximum number of copies).

In some implementations, the copy engine 512 has a minimum number of copies (e.g., a default number or a number received from user preferences), but makes additional copies, for example, by making the maximum number of copies as described above. In these implementations, the copy engine 512 can optionally flag a number of copies exceeding the minimum number. When the copy engine 512 needs to store copies of a different file, but does not have enough storage space available, the copy engine can delete the flagged copies to create additional storage space. In some implementations, the copy engine 512 selects which flagged copies to delete based on their physical location in storage. For example, the copy engine can select copies to delete so that the remaining copies are distributed across multiple storage devices. As another example, the copy engine can select copies to delete so that the remaining copies on any one storage device are physically distributed throughout the storage device (e.g., are stored in different places on a disk).

The copy engine 512 determines where to store each copy according to one or more storage preference policies. In general, the copy engine 512 has a default preference policy and optionally has one or more user-specified preference policies. A given preference policy can specify the order of preference for available storage devices and optionally specifies how many copies should be stored on each storage device. For example, one possible preference policy is store as many copies as possible on remote storage, store as many copies as possible on external storage, and then store any remaining copies on local storage. Another preference policy is store equal (or as close to equal as possible) numbers of copies on all available storage devices. In some implementations, the preference policy specifies different preferred orders or different numbers of copies for different types of files. In some implementations, the preference policy considers how frequently a file is accessed. For example, if a file is accessed more frequently, it can be identified as an “important” file to the user, and more copies of the file can be made. In some implementations, the preference policy considers whether or not remote storage devices are available for storing a file. If no remote storage devices are available, then additional local copies can be made.

The verification engine 514 verifies a user's identity (e.g., before the safe deposit box window is shown to the user). In some implementations, the verification engine 514 verifies a user's identity by receiving a user name and password and comparing them to a stored user name and password (e.g., as described above with reference to FIG. 3). Other verification techniques are possible, for example, the verification engine 514 can verify a password or passphrase provided by the user by comparing it to a stored password or passphrase, verify a token associated with the user (e.g., a token associated with a USB device inserted into the computer, or a token associated with a device that is within wireless range of the computer—for example, connected to the computer over Bluetooth), authenticate an identity of a mobile device associated with a user (e.g., by authenticating that radio frequency signals, such as Bluetooth™, received from a device in the vicinity of the computer are from a device associated with the user), verify that a user has logged onto specified networks (wireless, Ethernet, virtual private networks, etc.), or verify biometric data received from a user (e.g., by using face recognition techniques, verifying a user's fingerprint, verifying a user's voice, or verifying a retinal scan of the user). In some implementations, a combination of multiple verification techniques are used. Using multiple verification techniques can lead to greater security for the files and folders stored in the safe deposit box. In some implementations, access is only allowed during certain times (e.g., certain hours of the day or certain days of the week).

The permissions engine 516 determines permissions associated with a particular file and allows a user only the appropriate access to the file. For example, the permissions engine 516 can determine whether a user should be allowed read-only access to a file (e.g., as might be appropriate for a copy of a document that is being kept for record keeping purposes but should not be modified) or whether a user should be allowed to both view and modify the file (e.g., as might be appropriate for a document the user is currently editing). As another example, the permissions can include whether a file can be copied or transferred from the computer. The permissions can be specified, for example, by a user at the time the user adds the file (or a folder containing the file) to the safe deposit box, or at a later time.

### Example Processes

### Adding Files to the Safe Deposit Box

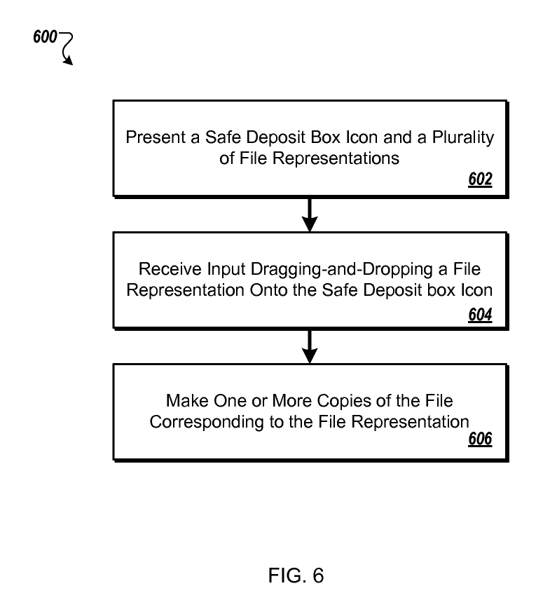

FIG. 6 is a flow diagram of example process 600 for receiving input adding a file to a safe deposit box. For convenience, the example process 600 will be described in reference to a system that performs the process 600. The system can be, for example, the safe deposit box manager 502.

The system presents a safe deposit box icon and a plurality of file representations (602), for example, as described above with reference to FIGS. 1A-B. Each file representation corresponds to a file stored on a storage device. The system receives input dragging-and-dropping a file representation onto the safe deposit box (604), for example, as described above with reference to FIG. 1B. The file representation can be, for example, a representation of a file or a representation of a folder storing one or more files or other folders. The system makes one or more copies of the file corresponding to the file representation (606). In some implementations, the file representation is a representation of a folder, and the system copies (and optionally encrypts) each file included in the folder. In some implementations, the system stores each of the copies on a storage device selected from a number of available (i.e., accessible by the system) storage devices. The storage device for each copy can be selected based on a preferred order of the storage devices and an available capacity of the storage devices, for example, as described above with reference to FIG. 5. In some implementations, at least one of the copies is stored on a remote storage device accessible through the network.

In some implementations, the system additionally encrypts the file and each of the one or more copies of the file. The system may also identify past versions of the file and encrypt the past versions, for example, as described above with reference to FIG. 5.

### Storing Files in Safe Deposit Box and Allowing Access to the Files

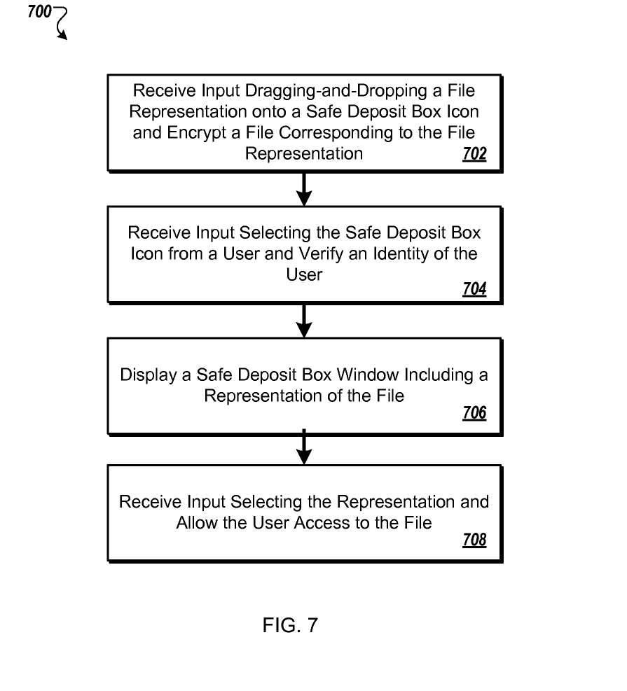

FIG. 7 is a flow diagram of example process 700 for adding a file to a safe deposit box and allowing a user access to the file through the safe deposit box. For convenience, the example process 700 will be described in reference to a system that performs the process 700. The system can be, for example, the safe deposit box manager 502.

The system receives input dragging-and-dropping a file representation onto a safe deposit box icon and encrypts a file corresponding to the file representation (702), for example, as described above with reference to FIGS. 1B-C. In some implementations, the system additionally creates one or more copies of the file and encrypts each copy. In some implementations, the file representation is a representation of a folder, and the system encrypts (and optionally copies) each file included in the folder. The system receives input from a user selecting the safe deposit box icon (704), and verifies the identity of the user, for example, as described above with reference to FIGS. 3A and 5. The system displays a safe deposit box window including a representation of the file (706), for example, as described above with reference to FIG. 3B. The system receives input selecting the representation and allows the user access to the file (708), for example, as described above with reference to FIGS. 3B and 5. Providing access can include decrypting the file, if necessary, and providing appropriate access permissions to the file. In some implementations, when the original copy of the file is no longer available (e.g., because of a disk failure of the storage device storing the file), a copy of the file is provided to the user instead. In some implementations, when the user modifies the file, any copies of the file are also updated to reflect the user's modifications. The copies of the file can be identified, for example, from the data maintained by the copy engine, for example, as described above with reference to FIG. 5. These steps can be performed by a native file system that is part of an operating system (e.g., Mac OS,™ Windows™, or Linux™).

In some implementations, the system closes the safe deposit box window, for example, after a predetermined period of time or a predetermined period of inactivity, as described above with reference to FIG. 5.

The features described can be implemented in digital electronic circuitry, or in computer hardware, firmware, software, or in combinations of them. The features can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be coupled by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. For example, modules 404, 406, 408, 410, 412, 414, and 416 need not perform all, or any, of the functionality attributed to that module in the implementations described above, and all or part of the functionality attributed to one module may be performed by another module, another additional module, or not performed at all. Accordingly, other implementations are within the scope of the following claims.

What is claimed is:

1. A computer-implemented method, comprising:
presenting an icon and a plurality of file representations on a display device, each file representation corresponding to a file stored on a first storage device;
receiving input dragging-and-dropping a selected file representation in the plurality of file representations onto the icon; and
in response to receiving the input, making one or more copies of the file corresponding to the selected file representation.

2. The method of claim 1, wherein the icon is a representation of a safe deposit box.

3. The method of claim 2, wherein the icon is animated.

4. The method of claim 1, wherein presenting the icon includes presenting the icon in a dock.

5. The method of claim 1, further comprising encrypting the file and at least one of the one or more copies.

6. The method of claim 1, wherein each of the one or more copies of the file is stored on a second storage device in a plurality of storage devices, the second storage device determined based on a preferred order of the storage devices and a capacity of the storage devices.

7. The method of claim 6, wherein the preferred order is determined from a preference policy.

8. The method of claim 1, wherein at least one of the one or more copies is stored on a remote storage device accessible through a network.

9. The method of claim 1, further comprising identifying one or more past versions of the file corresponding to the selected file representation, and encrypting at least one of the past versions of the file.

10. The method of claim 1, further comprising modifying the icon in response to receiving input dragging the selected file representation over the icon.

11. A computer-implemented method, comprising:
receiving first input from a user, the first input dragging-and-dropping a first file representation onto an icon, and encrypting a file corresponding to the first file representation in response to the first input;
receiving second input from the user, the second input selecting the icon, and verifying an identity of the user in response to the second input;
displaying a window including a second file representation of the file on a display device; and
receiving third input from the user, the third input selecting the second file representation, and then allowing the user access to the file.

12. The method of claim 11, further comprising making one or more encrypted copies of the file in response to the first input.

13. The method of claim 11, wherein verifying the identity of the user includes processing radio frequency signals received from a nearby device to verify that the device is associated with the user.

14. The method of claim 11, wherein verifying the identity of the user includes verifying biometric data for the user.

15. The method of claim 11, wherein allowing the user access to the file includes allowing the user to view, but not modify, the file.

16. The method of claim 11, wherein allowing the user access to the file includes allowing the user to modify the file.

17. The method of claim 11, further comprising closing the window after a predetermined time period.

18. The method of claim 11, further comprising closing the window after a predetermined period of inactivity.

19. The method of claim 8, further comprising detecting that radio frequency signals from a device associated with the user are no longer being received, and then closing the window.

20. A system comprising:
a processor;
a display device;
one or more storage devices; and
a computer-readable medium coupled to the processor and including instructions, which, when executed by the processor, causes the processor to perform operations comprising:
presenting an icon and a plurality of file representations on the display device, each file representation corresponding to a file stored on a first storage device in the one or more storage devices;
receiving input dragging-and-dropping a selected file representation in the plurality of file representations onto the icon; and
in response to receiving the input, making one or more copies of the file corresponding to the selected file representation, and storing the copies on the one or more storage devices.

21. The system of claim 20, wherein the processor further performs operations comprising encrypting the file and at least one of the one or more copies.

22. The system of claim 20, wherein each copy is stored on a storage device determined based on a preferred order of the one or more storage devices and a capacity of the one or more storage devices.

23. The system of claim 20, wherein the processor further performs operations comprising:
displaying a window on the display device, the window displaying a representation of the file;
receiving input from a user selecting the representation of the file, and allowing the user access to the file.

24. A system, comprising:
a processor;
a display device; and
a computer-readable medium coupled to the processor and including instructions, which, when executed by the processor, causes the processor to perform operations comprising:
receiving first input from a user, the first input dragging-and-dropping a first file representation onto an icon, and encrypting a file corresponding to the first file representation in response to the first input;
receiving second input from the user, the second input selecting the icon, and verifying an identity of the user in response to the second input;
displaying a window including a second file representation of the file on the display device; and
receiving third input from the user, the third input selecting the second file representation, and then allowing the user access to the file.

25. A computer-readable medium having instructions stored thereon, which, when executed by a processor, causes the processor to perform operations comprising:
receiving first input dragging-and-dropping a first file representation onto an icon and encrypting a file corresponding to the first file representation in response to the first input;
receiving second input from a user, the second input selecting the icon, and verifying an identity of the user in response to the second input;
displaying a window including a second file representation of the file on a display device; and
receiving third input selecting the second file representation, and then allowing the user access to the file.
